(19) United States
(12) Patent Application Publication
(10) Pub. No.: US 2016/0204667 A1
(43) Pub. Date: Jul. 14, 2016

(54) SUPERCONDUCTING ELECTRICAL MACHINE WITH COMPLIANT WINDING SUPPORT

(71) Applicants: Darrell Morrison, Eagle Lake, MN (US); Keith T. Dennehy, Winona, MN (US)

(72) Inventors: Darrell Morrison, Eagle Lake, MN (US); Keith T. Dennehy, Winona, MN (US)

(21) Appl. No.: 14/593,928

(22) Filed: Jan. 9, 2015

(51) Int. Cl. H02K 3/30

(52) U.S. Cl. CPC H02K 3/30

(57) ABSTRACT

A superconducting electrical machine includes a stator and a rotor configured to rotate in a cavity defined by the stator. The rotor and the stator each include superconducting windings. The rotor and the stator also each include a composite configured to compensate for a volume change of various components of the rotor and stator during a change in temperature from a first temperature to a second temperature.

### BACKGROUND

The present invention relates generally to the field of electrical machines for energy conversion, such as motors and generators. Motors convert electricity into mechanical energy. Generators generate electricity by converting mechanical energy into electrical energy. A prime mover, such as an engine driving a rotating shaft, provides the mechanical energy. A rotor having permanent magnets or electromagnets rotates with the rotating shaft, generating a magnetic field that causes electricity to be generated in a stationary stator.

Superconducting electrical machines, such as a superconducting generator, use the principle of superconductivity to significantly reduce the electrical resistance in the conductors of the generator. Superconductivity requires maintaining the conductors at very low temperatures. The very low temperatures can lead to unique structural stresses on various components of the superconducting electrical machines.

### SUMMARY

One embodiment of the invention relates to a superconducting electrical machine. The superconducting electrical machine includes a stator that includes stator superconducting windings configured to superconduct when cooled to a temperature no greater than a stator superconducting temperature. The stator also includes stator structural material surrounding the stator superconducting windings. The superconducting electrical machine also includes a rotor configured to rotate in a cavity defined by the stator. The rotor includes rotor superconducting windings configured to superconduct when cooled to a temperature no greater than a rotor superconducting temperature. The rotor also includes rotor structural material surrounding the rotor superconducting windings. The superconducting electrical machine also includes at least one composite for supporting at least one of the stator superconducting windings, the stator structural material, the rotor superconducting windings, and the rotor structural material. The at least one composite includes a layer including an epoxy resin and a filler. The filler includes spherical beads defining a volume fraction. The volume fraction is configured to compensate for a volume change of the at least one of the stator superconducting windings, the stator structural material, the rotor superconducting windings, and the rotor structural material, during a change in temperature from a first temperature to a second temperature.

Another embodiment of the invention relates to a superconducting electrical machine. The superconducting electrical machine includes a stator that includes stator superconducting windings configured to superconduct when cooled to a temperature no greater than a stator superconducting temperature. The superconducting electrical machine also includes a rotor configured to rotate in a cavity defined by the stator. The rotor includes rotor superconducting windings configured to superconduct when cooled to a temperature no greater than a rotor superconducting temperature. The superconducting electrical machine also includes at least one composite for supporting at least one of the stator superconducting windings and the rotor superconducting windings. The at least one composite includes a layer including an epoxy resin and a filler. The filler includes spherical beads defining a volume fraction. The volume fraction is configured to compensate for a volume change of the at least one of the stator superconducting windings and the rotor superconducting windings during a change in temperature from a first temperature to a second temperature.

Another embodiment of the invention relates to a superconducting electrical machine. The superconducting electrical machine includes a stator that includes stator superconducting windings configured to superconduct when cooled to a temperature no greater than a stator superconducting temperature. The stator also includes stator structural material surrounding the stator superconducting windings. The superconducting electrical machine also includes a rotor configured to rotate in a cavity defined by the stator. The rotor includes rotor superconducting windings configured to superconduct when cooled to a temperature no greater than a rotor superconducting temperature. The rotor also includes rotor structural material surrounding the rotor superconducting windings. The superconducting electrical machine also includes at least one composite for supporting at least one of the stator and the rotor. The at least one composite includes a layer including an epoxy resin and a filler. The filler includes spherical beads defining a volume fraction. The volume fraction is configured to compensate for a volume change of the at least one of the stator and the rotor during a change in temperature from a first temperature to a second temperature.

Another embodiment relates to a superconducting electrical machine. The superconducting electrical machine includes a stator and a rotor. The rotor is configured to rotate in a cavity defined by the stator. At least one of the stator and the rotor includes superconducting windings, structural material surrounding the superconducting windings, and a composite for supporting at least one of the superconducting windings and the structural material. The superconducting windings are configured to superconduct when cooled to a temperature no greater than a cryogenic temperature. The composite includes a layer including an epoxy resin and a filler. The filler includes spherical beads that define a volume fraction. The volume fraction is configured to compensate for a volume change of the at least one of the superconducting windings and the structural material, during a change in temperature from a first temperature to a second temperature.

Another embodiment relates to a superconducting electrical machine. The superconducting electrical machine includes a stator and a rotor. The rotor is configured to rotate in a cavity defined by the stator. The rotor includes rotor superconducting windings, rotor structural material surrounding the rotor superconducting windings, and a rotor composite. The rotor superconducting windings are configured to superconduct when cooled to a temperature no greater than a rotor superconducting temperature. The rotor composite supports at least one of the rotor superconducting windings and the rotor structural material during a change in temperature from a first temperature to a second temperature.

Another embodiment relates to a superconducting electrical machine. The superconducting electrical machine includes a stator and a rotor. The rotor is configured to rotate in a cavity defined by the stator. The stator includes stator superconducting windings, stator structural material surrounding the stator superconducting windings, and a stator composite. The stator superconducting windings are configured to superconduct when cooled to a temperature no greater than a stator superconducting temperature. The stator composite supports at least one of the stator superconducting windings and the stator structural material during a change in temperature from a first temperature to a second temperature.

Alternative embodiments relate to other features and combinations of features as may be generally recited in the claims.

### BRIEF DESCRIPTION OF THE DRAWINGS

The invention will become more fully understood from the following detailed description, taken in conjunction with the accompanying figures, in which like reference numerals refer to like elements.

FIG. 1 is a perspective view of a superconducting electrical machine, in accordance with one embodiment.

FIG. 2 is a perspective view of a superconducting electrical machine driven by a wind turbine, in accordance with one embodiment.

FIG. 3 is a perspective view of a superconducting electrical machine driven by a wind turbine, in accordance with one embodiment.

FIG. 4 is a side view of the superconducting electrical machine of FIG. 1.

FIG. 5 is an end view of the drive end of the superconducting electrical machine of FIG. 1.

FIG. 6 is an end view of the non-drive end of the superconducting electrical machine of FIG. 1.

FIG. 7 is an exploded perspective view of the superconducting electrical machine of FIG. 1.

FIG. 8 is a schematic diagram of a system including a superconducting electrical machine in accordance with one embodiment.

FIG. 9 is a cross-sectional view of a superconducting electrical machine in accordance with one embodiment.

FIG. 10A is a sectional view of a superconducting electrical machine in accordance with one embodiment.

FIG. 10B is a detail view of the superconducting electrical machine of FIG. 10A.

FIG. 11 is a perspective view of the active section and rotor windings and stator windings of a superconducting electrical machine in accordance with one embodiment.

FIG. 12 is a perspective view of the active section of a rotor showing the winding placement for a superconducting electrical machine in accordance with one embodiment.

FIG. 13 is a perspective view of the active section and outer layers of a stator of a superconducting electrical machine in accordance with one embodiment.

FIG. 14A is a partial view of the active section and various layers of a stator of a superconducting electrical machine in accordance with one embodiment.

FIG. 14B is a partial view of the active section and various layers of a rotor of a superconducting electrical machine in accordance with one embodiment.

FIG. 15 is a cutaway view of the active sections of a rotor of a superconducting electrical machine in accordance with one embodiment.

FIG. 16 is a sectional view of the superconductor and composite of a superconducting electrical machine in accordance with one embodiment.

FIG. 17 is a detail view of the superconductor and composite of FIG. 16.

FIG. 18A is a chart illustrating thermal expansion properties of materials in a superconducting electrical machine in accordance with one embodiment.

FIG. 18B is a chart illustrating thermal expansion properties of materials in a superconducting electrical machine in accordance with one embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, superconducting electrical machines include a stator supported in a stator frame and a rotor configured to rotate in a cavity defined by the stator. The rotor and stator are each surrounded by a cryostat to maintain a vacuum at cryogenic temperatures around the rotor and the stator. A cryocooler provides coolants to the rotor and the stator to maintain the rotor and the stator at cryogenic temperatures. The rotor may be rotated using mechanical energy from a prime mover (e.g., engine, gas turbine, wind turbine, etc.). The rotor and stator each include active sections with superconducting windings and supporting structural material that may undergo a volume change during a change in temperature from a first temperature, such as a room temperature, to a second temperature, such as a cryogenic temperature at which the windings superconduct. The rotor and stator also each include a composite for supporting the rotor and the stator. The composite includes an epoxy or similar resin and a filler. The filler includes spherical beads. A volume fraction of the spherical beads is configured to compensate for a volume change of the rotor and/or the stator, or components of the rotor and/or the stator, during the change in temperature from the first temperature to the second temperature.

Generally, the term volume change may encompass any change in a volume of a superconducting electrical machine or a component of a superconducting electrical machine (e.g., a rotor, a stator, superconducting windings, etc.). A volume change may refer to any change in dimensions of a superconducting electrical machine or a component of a superconducting electrical machine, such as an expansion or a contraction. A volume change may be a thermal volume change induced by a change in temperature of a material. An expansion or contraction may occur in one dimension, two dimensions, or three dimensions. An expansion or contraction may occur in some dimensions at some temperatures, and in other dimensions at other temperatures. An expansion or contraction may be measured by various techniques, such as by comparing a change in a dimension of a material (e.g. length, etc.), to an initial dimension of the material. A material property such as a thermal expansion coefficient may be used regarding volume changes for a material. The thermal expansion coefficient may correspond to various volume changes, including a contraction that occurs when the temperature of a material decreases and an expansion that occurs when the temperature of a material increases.

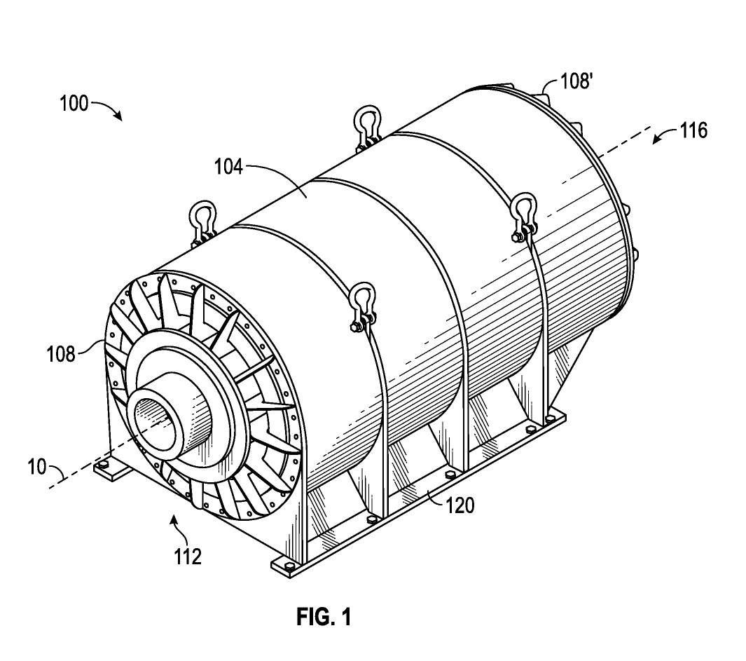

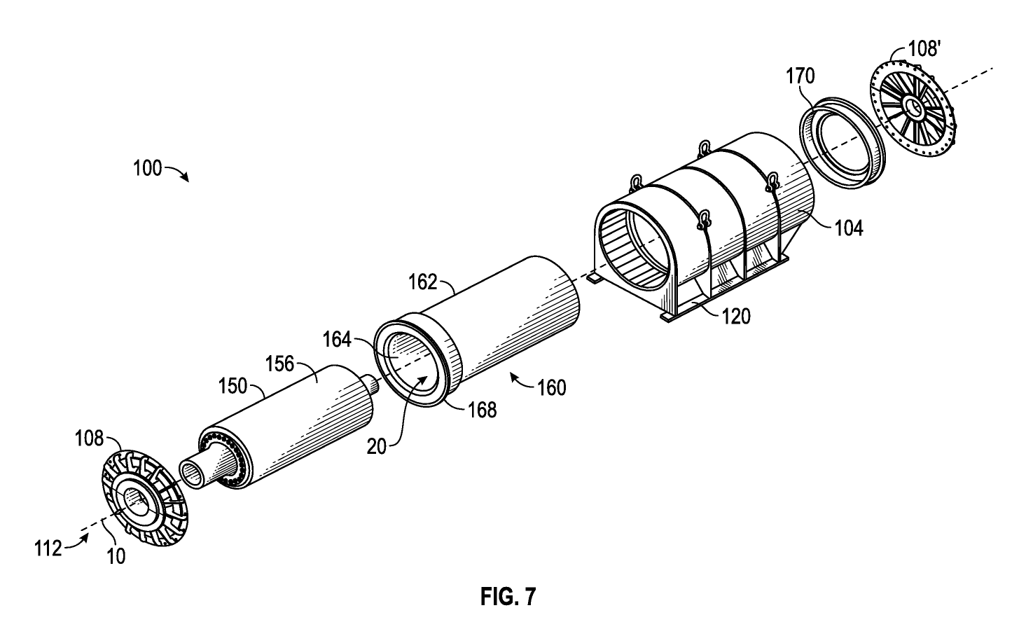

Referring to FIG. 1, in some embodiments, superconducting electrical machine 100 includes a stator frame 104. Stator frame 104 may be a housing that supports a stator (e.g., stator 160 shown in FIG. 7). In some embodiments, the stator frame 104 includes a shape that is substantially a cylindrical shell. The superconducting electrical machine 100 may also include a base 120 attached to the stator frame 104 to support the weight of the superconducting electrical machine 100.

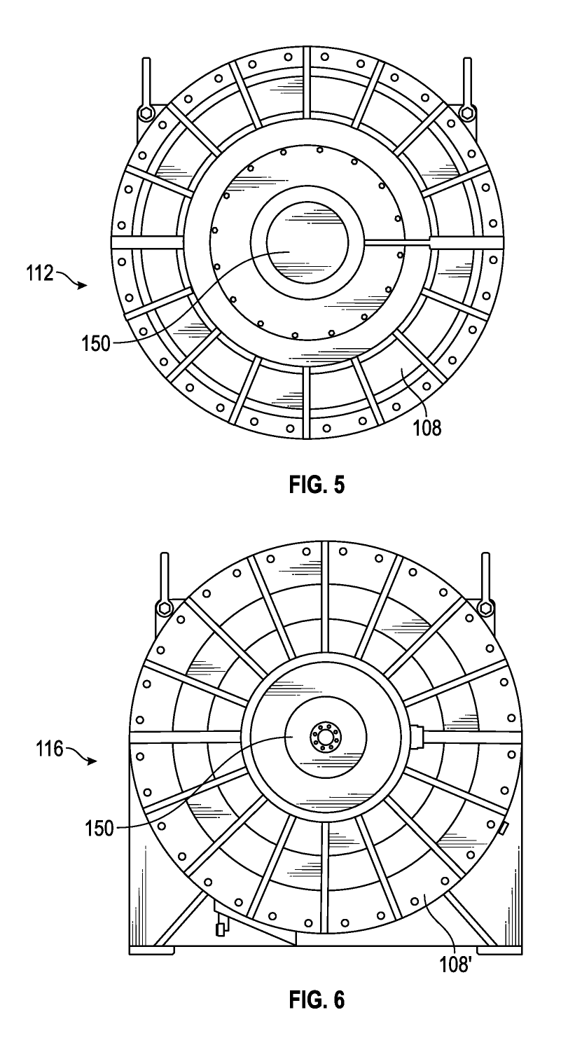

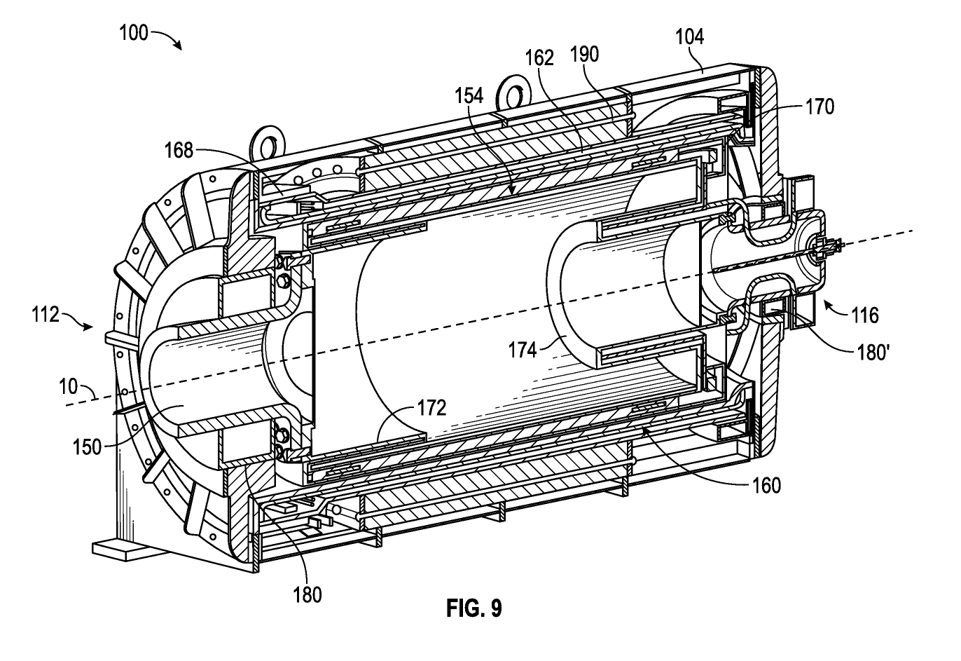

Superconducting electrical machine 100 may include a pair of bracket assemblies 108, 108′ disposed at a drive end 112 and a non-drive end 116 of the superconducting electrical machine 100. The pair of bracket assemblies 108, 108′ may include a pair of bearings to support a rotor and accommodate rotation of the rotor about a longitudinal axis 10 (see, e.g., bearings 180, 180′ shown in FIG. 9, rotor 150 shown in FIGS. 5-7). A longitudinal axis 10 may pass through the superconducting electrical machine 100 and perpendicular to a pair of planes substantially defined by the pair of bracket assembles 108, 108′.

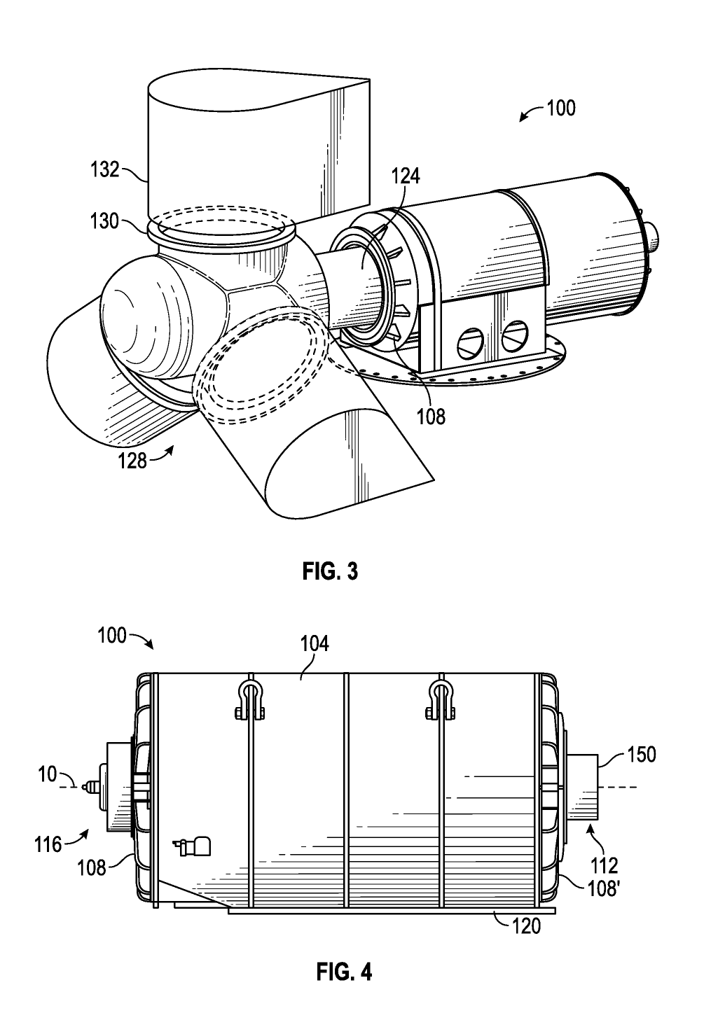

A drive end 112 is an end region of a superconducting electrical machine 100 proximate to a prime mover, such as a wind turbine, and at which a shaft (e.g., shaft 124 shown in FIG. 3) may be received from the prime mover. A non-drive end 116 is an end region of the superconducting electrical machine 100 located on an opposite end of the superconducting electrical machine 100 from the drive end 112.

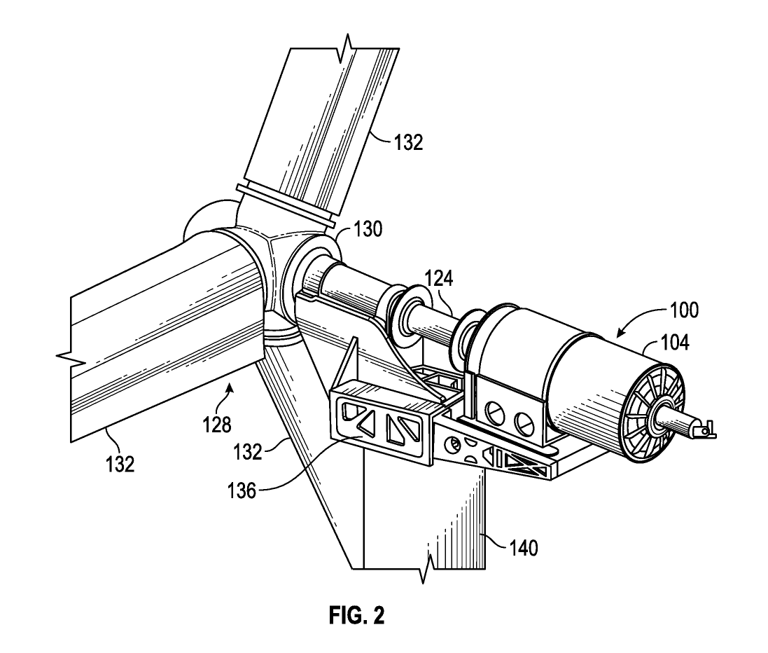

Referring to FIG. 2, in some embodiments, a superconducting electrical machine 100 is driven by a shaft 124 coupled to a wind turbine 128. The wind turbine 128 may include a mainframe 136 supported by a tower 140. In some embodiments, including but not limited to offshore wind applications, the tower 140 may be configured to stand on an ocean floor and withstand tidal action, storms, and other physical impacts of both continuous and transitory natures. In some embodiments, including but not limited to land-based wind applications, the tower 140 may be configured to stand on any kind of terrain and withstand storms and other physical impacts of both continuous and transitory natures.

In various embodiments, a superconducting electrical machine 100 is driven by various prime movers. For example, the superconducting electrical machine 100 may be driven by an engine, such as an engine using oil, gasoline, diesel, or other fossil fuels as a fuel source. The superconducting electrical machine 100 may be driven by a gas turbine. The superconducting electrical machine 100 may be driven by a nuclear reactor steam turbine, such as in a naval submarine. The superconducting electrical machine 100 may be used in various naval contexts, such as with oil, gasoline, or diesel engines; with gas turbines; in coordination with a propulsion motor benefiting from the high specific torque of the superconducting electrical machine 100; etc.

In some embodiments, a wind turbine 128 includes a plurality of blades 132 configured to rotate a shaft 124 when acted upon by a force, such as a force generated by wind. The plurality of blades 132 may extend radially from a central hub 130 which is coupled to the shaft, and the plurality of blades 132 may rotate the central hub 130 and in turn rotate the shaft when acted upon by a force. The plurality of blades 132 may include three blades 132 arranged in a circular configuration. In some embodiments, the plurality of blades 132 are arranged in a circular configuration and spaced equidistantly from each other, the plurality of blades being spaced by approximately 60 degrees from each other. In some embodiments, a wind turbine 128 drives a first shaft 124, which is coupled to a second shaft for driving a superconducting electrical machine 100. An intermediate shaft may also be coupled between the first shaft 124 and the second shaft.

Referring to FIG. 3, in some embodiments, a wind turbine 128 includes a plurality of blades 132 extending from a central hub 130. The central hub 130 may be coupled to a shaft 124. The shaft 124 may pass directly through the bracket 108 at the drive end 112 of the superconducting electrical machine, into a rotor (e.g. rotor 150 shown in FIG. 7). The shaft 124 may be coupled to the rotor 150 to directly rotate the rotor 150 and drive the superconducting electrical machine 100. In some embodiments, the shaft 124 rotates the rotor 150 at a constant rate. In some embodiments, the superconducting electrical machine 100 is configured for variable speed operation. A voltage regulator may be used to account for variations in voltage due to variations in the rotation rate of the shaft 124. In some embodiments, the shaft 124 is configured to rotate the rotor at approximately 10 revolutions per minute.

Referring to FIG. 4, a side view of a superconducting electrical machine 100 is shown. The superconducting electrical machine 100 may include a stator frame 104, a pair of bracket assemblies 108, 108′ disposed at a drive end 112 and at a non-drive end 116 of the superconducting electrical machine 100, and a base 120 disposed below the stator frame 104 to support the superconducting electrical machine 100. A longitudinal axis 10 may pass through the superconducting electrical machine 100. The superconducting electrical machine 100 may include a rotor 150, the rotor 150 being coannular with the stator frame 104. The rotor 150 may be supported in the superconducting electrical machine 100 by the pair of bracket assemblies 108, 108′.

Referring to FIG. 5, an end view of a superconducting electrical machine 100 including a drive end 112 is shown. The drive end 112 may be located at an end region of the superconducting electrical machine 100 proximate to a prime mover, such as a wind turbine. Superconducting electrical machine may include a bracket assembly 108 disposed at the drive end 112. The bracket assembly 108 may surround and be coannular with a bearing (e.g., bearing 180 shown in FIG. 9). In some embodiments, the bearing 180 is an anti-friction bearing 180, and the bearing 180 accommodates rotation of a rotor 150. The bearing 180 may surround and be coannular with the rotor 150. In some embodiments, the bearing 180 receives a shaft from a prime mover for rotating the rotor 150 (e.g., shaft 124 shown in FIG. 3).

Referring to FIG. 6, an end view of a superconducting electrical machine 100 including a non-drive end 116 is shown. The non-drive end 116 may be located at an end region of the superconducting electrical machine 100 distal from a prime mover, such as a wind turbine, and opposite from a drive end (e.g. drive end 112 shown in FIG. 5). Superconducting electrical machine 100 may include a bracket assembly 108′ disposed at the non-drive end 116. The bracket assembly 108′ may surround and be coannular with a bearing (e.g., bearing 180′ shown in FIG. 9). In some embodiments, the bearing 180′ is an anti-friction bearing 180′, and the bearing 180′ accommodates rotation of a rotor 150. The bearing 180′ may surround and be coannular with the rotor 150.

Referring to FIG. 7, an expanded view of various components of a superconducting electrical machine 100 is shown. The superconducting electrical machine 100 may include a stator frame 104 attached to a base 120. The superconducting electrical machine 100 may include a pair of bracket assemblies 108, 108′ disposed at a drive end 112 and a non-drive end 116 of the superconducting electrical machine 100. The superconducting electrical machine 100 may include a rotor 150 supported by the bracket assemblies 108, 108′ and which rotates about a longitudinal axis 10.

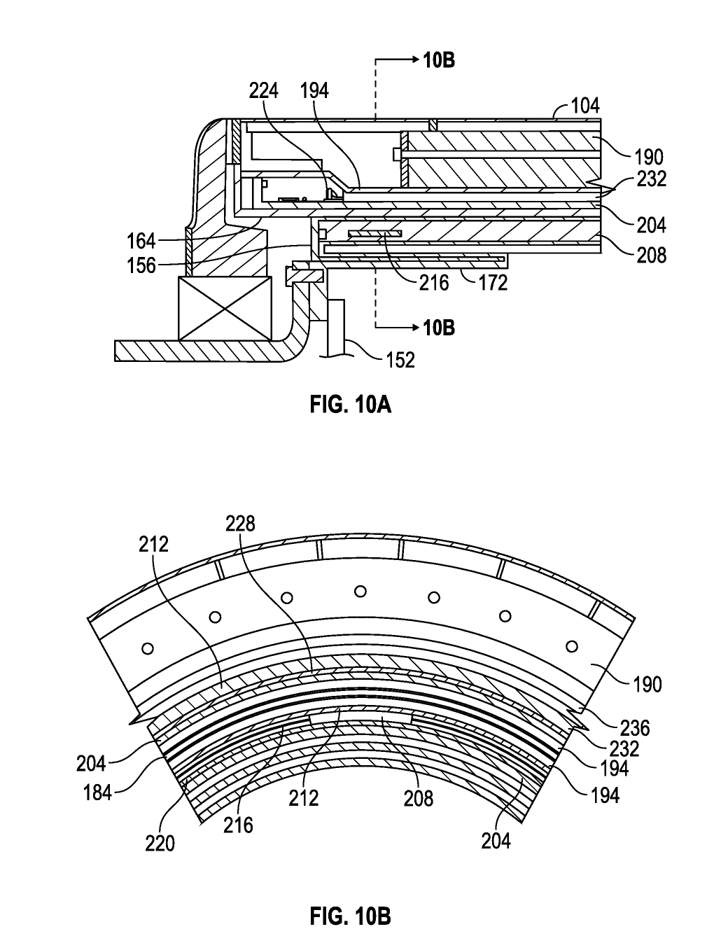

The superconducting electrical machine 100 may include a stator 160. As shown in FIG. 7, the stator 160 includes an active section 162, and superconductive processes may occur in the active section 162. FIG. 7 also shows a stator re-entrant drive end 168 disposed at a drive end 112 of the stator 160, and a stator re-entrant non-drive end 170 disposed at a non-drive end 116 of the stator 160. Re-entrant ends, such as the stator non-drive re-entrant end 170, provide an elongated pathway for thermal conduction from the stator 160 to the environment surrounding the superconducting electrical machine 100, improving the ability of the superconducting electrical machine 100 to maintain the cryogenic temperatures required for superconductive processes to occur. Re-entrant ends, such as the stator non-drive re-entrant end 170, also provide radial and axial flexibility to accommodate thermal expansion and/or thermal contraction of the active section 162. An inner surface of the stator 160 defines a cavity 20 in which the rotor 150 may be disposed. In some embodiments, the inner surface is defined by a stator cryostat 164 which maintains a vacuum environment within the stator 160. An outer surface of the rotor 150 may also be defined by a rotor cryostat 156 which maintains a vacuum environment within the rotor 150. Cryostats, such as the stator cryostat 164 and the rotor cryostat 156, improve the ability of the superconducting electrical machine 100 to maintain a cryogenic environment, by providing a vacuum environment surrounding each of the stator 160 and the rotor 150. In some embodiments, an air gap remains between the stator cryostat 164 and the rotor cryostat 156 after the rotor 150 has been positioned within the cavity 20 (see, e.g., air gap 184 shown in FIGS. 9, 10B).

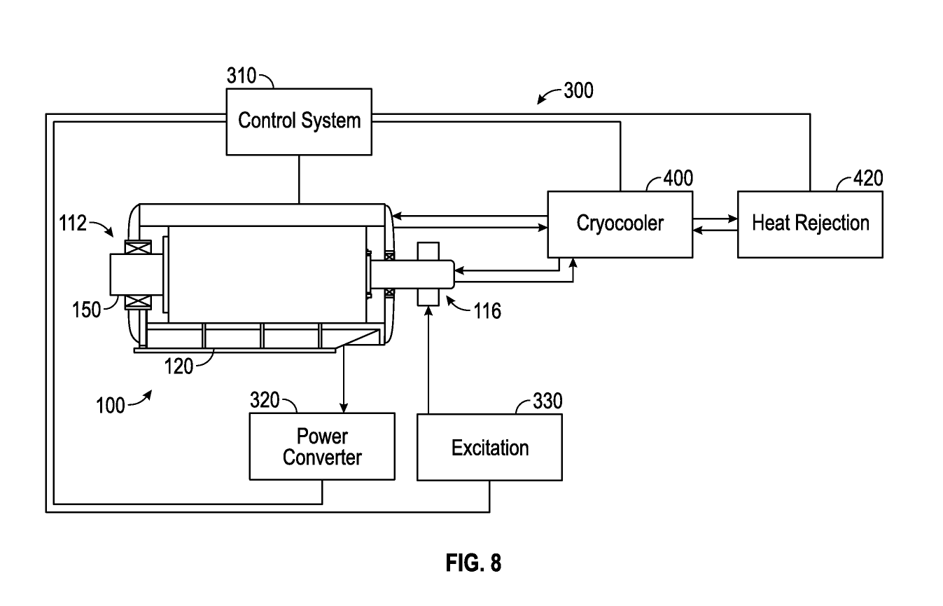

Referring to FIG. 8, a system 300 for operating a superconducting electrical machine 100 is shown. The system 300 includes a superconducting electrical machine 100, a control system 310, a power converter 320, an excitation device 330, a cryocooler 400, and a heat rejection unit 420. The control system 310 may control operation of the various components of system 300. For example, the control system 310 may modulate the rotation of a rotor 150, depending on factors including but not limited to the rotation rate of a shaft from a prime mover such as a wind turbine (e.g. shaft 124, wind turbine 128 shown in FIG. 2).

A cryocooler 400 may control the flow rates of coolants provided to a superconducting electrical machine 100, in order to control a temperature within the superconducting electrical machine 100. For example, the cryocooler 400 may control a temperature of a stator 160, a temperature of a rotor 150, a temperature of components of the stator 160 or of the rotor 150, etc. The cryocooler 400 may control the flow rates of the coolants in order to maintain a temperature within the superconducting electrical machine 100 at or below a cryogenic temperature. Temperatures within the superconducting electrical machine 100 may be measured in a variety of ways (e.g., temperatures may be measured using sensors disposed throughout the superconducting electrical machine, etc.).

The power converter 320 may convert electrical energy generated by the superconducting electrical machine 100 to a form compatible with electrical components outside of system 300. For example, the superconducting electrical machine 100 may generate variable frequency power, which may be rectified and inverted before transmission to an electrical grid.

The excitation device 330 may provide an excitation current to the rotor 150 so that the rotor superconducting windings 208 of the rotor 150 may generate a magnetic field. In some embodiments, a control system 310 controls operation of the excitation device 330 to dynamically modulate the excitation current in response to conditions including but not limited to wind conditions. In some embodiments, a change in the excitation current leads to an inductive voltage, requiring power to be supplied from the excitation device 330 to the rotor 150. For example, as shown in FIG. 8, the excitation device 330 provides power to the rotor 150 near the non-drive end 116 region of the rotor 150. In some embodiments, the excitation current is modulated over long time constants (e.g., several minutes) in response to conditions including but not limited to wind conditions and/or for providing variable speed operation.

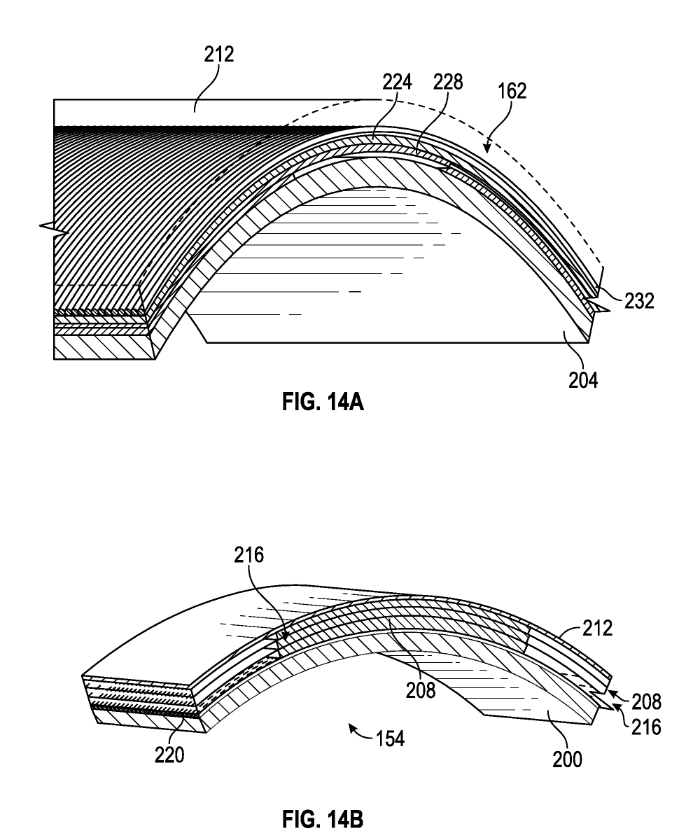

The cryocooler 400 may be coupled to a superconducting electrical machine 100, and the cryocooler 400 may drive a cooling cycle, such as a reverse-Brayton cycle, in order to provide coolants to the superconducting electrical machine 100. The coolants may pass from the cryocooler 400, which has cooled the coolants to a temperature at or below a cryogenic temperature, through cooling tubes in the active sections of a rotor 150 and a stator (e.g., stator 160 shown in FIG. 7; rotor cooling tubes 220 and stator cooling tubes 224 shown in FIGS. 10A-10B). The coolants may draw thermal energy from the active sections, and particularly the superconductors of the rotor 150 and the stator 160 (e.g. rotor superconducting windings 208 and stator superconducting windings 228 showing in FIGS. 14A-14B). By drawing thermal energy from the active sections, the coolants help maintain the superconductors at a cryogenic temperature. After drawing thermal energy from the active sections, the relatively warm coolants may return to the cryocooler 400, and the cycle may begin again.

In some embodiments, the coolant includes gaseous helium. Cryocooler 400 may include a Turbo-Brayton cryocooler which provides a coolant of helium (e.g., helium gas having a temperature of approximately 15-20 Kelvin, etc.) at a cryogenic temperature, to a rotor 150 and to a stator (e.g., stator 160 shown in FIG. 7). Cryocooler 400 may also provide a coolant of helium as an additional heat sink to the stator 160 (e.g., helium gas having a temperature of 60 Kelvin, etc.). After passing through the cooling tubes within the superconducting electrical machine 100 and receiving thermal energy from the superconducting electrical machine 100, the relatively warm coolant may pass through a heat exchanger. The heat exchanger may exchange thermal energy from the relatively warm coolant to a second coolant (e.g., liquid, gas, a combination thereof, etc.), such as a solution of water and a glycol (e.g. water and propylene glycol, water and ethylene glycol, etc.). The second coolant may be at a temperature close to room temperature (e.g., 293 Kelvin, 298 Kelvin, etc.).

Referring to FIG. 9, a cross-section of a superconducting electrical machine 100 is shown. Superconducting electrical machine 100 includes a rotor 150 and a stator 160. The rotor 150 may be coupled to a shaft and may be rotated by the shaft about a longitudinal axis 10 when the shaft rotates. The rotor 150 may be supported in the superconducting electrical machine 100 by a pair of bearings 180, 180′ which surround and are coannular with the rotor 150, and are disposed at the drive end 112 and the non-drive end 116 of the superconducting electrical machine 100. A pair of bracket assemblies 108, 108′ may surround and support the pair of bearings 180, 180′, and in turn, support the rotor 150. The rotor 150 may include a rotor active section 154, in which superconductive processes occur. The rotor 150 may include a rotor re-entrant drive end 172 and a rotor re-entrant non-drive end 174. The re-entrant ends 172, 174 may provide an extended path along which thermal conduction occurs from the rotor to an environment surrounding the superconducting electrical machine 100, which increases a resistance to thermal conduction, thus facilitating maintaining the superconducting electrical machine 100 at or below a cryogenic temperature. Re-entrant ends, such as the rotor re-entrant drive end 172 and a rotor re-entrant non-drive end 174, also provide radial and axial flexibility to accommodate thermal expansion and/or thermal contraction of the active section 154.

The stator 160 may be disposed generally surrounding and coannular with the rotor 150. The stator 160 may be supported by stator frame 104. The stator 160 may include a stator re-entrant drive end (e.g., stator re-entrant drive end 168 shown in FIG. 7) and a stator re-entrant non-drive end 170. The re-entrant ends 168, 170 may provide an extended path along which thermal conduction occurs from the rotor to an environment surrounding the superconducting electrical machine 100, which increases a resistance to thermal conduction, thus facilitating maintaining the superconducting electrical machine 100 at or below a cryogenic temperature. Re-entrant ends, such as the stator re-entrant drive end 168 and stator non-drive end 170, also provide radial and axial flexibility to accommodate thermal expansion and/or thermal contraction of an active section 162.

The stator 160 may be surrounded by an electromagnetic shield 190 which minimizes communication of electrical signals and energy across a boundary of the stator frame 104 and the superconducting electrical machine 100. In some embodiments, the electromagnetic shield is a laminated shield. In some embodiments, the electromagnetic shield is a back iron.

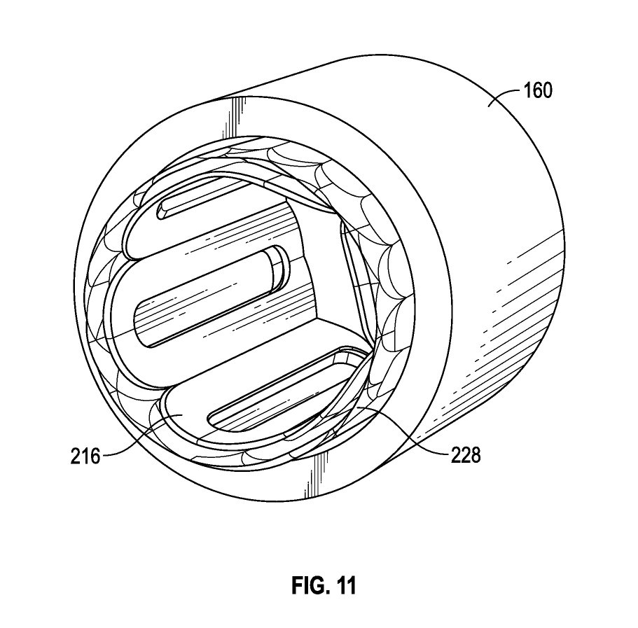

Referring to FIGS. 10A-10B, a section of a superconducting electrical machine 100 is shown. In some embodiments, a rotor (e.g., rotor 150 shown in FIG. 9) includes a rotor torque tube 200 surrounded by a rotor composite 208. The rotor composite 208 may include an epoxy or similar resin and filler configured to compensate for a volume change of the rotor. The rotor composite 208 may surround and support rotor superconducting windings 216 and rotor cooling tubes 220. The rotor cooling tubes 220 may be disposed between the rotor torque tube 200 and the rotor superconducting windings 216 in order to draw thermal energy from the rotor superconducting windings 216. An air gap 184 may be provided between the rotor cryostat 156 and the stator cryostat 164, when the rotor 150 is positioned within a cavity 20 defined by the stator (e.g., stator 160 shown in FIG. 7). The stator 160 may be disposed coannular with the rotor 150 and on an opposite side of the air gap 184. The stator may include stator cooling tubes 224 to draw thermal energy from stator superconducting windings (e.g., stator superconducting windings 228 shown in FIG. 11). A stator composite 232 may surround and support the stator superconducting windings 228 and stator cooling tubes 224. The stator composite 208 may be surrounded by a stator retention layer (e.g., stator retention layer 212 shown in FIG. 14A). An electromagnetic shield 190 may be provided along an outer region of the stator 160 to provide electrical insulation to the superconducting electrical machine 100. A shaft 152 may drive rotation of the rotor 150. An insulator, such as multi-layer insulation 194, may be provided along surfaces within the rotor 150 and the stator 160, such as along re-entrant ends. The multi-layer insulation 194 may improve the ability of the superconducting electrical machine 100 to maintain a cryogenic environment by increasing a resistance to heat transfer between components of the superconducting electrical machine 100.

The rotor composite 208 may be surrounded by a rotor retention layer 212. The rotor retention layer 212 may provide additional structural support to the rotor 150 during a change in temperature from a first temperature to a second temperature, and may also provide additional structural support to the rotor 150 during operation of the superconducting electrical machine 100. In various embodiments, rotor structural material may include various components of the rotor 150 (e.g., rotor torque tube 200, support layers, rotor retention layer 212, etc.). In some embodiments, rotor structural material may include metal, a metal alloy, stainless steel (e.g., 304 stainless steel), etc. In various embodiments, stator structural material may include various components of the stator 160 (e.g., stator torque tube 204, support layers, stator retention layer 212, etc.). In some embodiments, stator structural material may include metal, a metal alloy, stainless steel (e.g., 304 stainless steel), etc.

Referring to FIG. 11, a superconducting electrical machine 100 including active sections in which superconducting processes occur is shown. The superconducting electrical machine 100 includes a stator 160. The stator 160 includes stator superconducting windings 228. The superconducting electrical machine 100 also includes a rotor (e.g. rotor 150 shown in FIG. 9) including rotor superconducting windings 216.

In some embodiments, superconductors, such as rotor superconducting windings 216 and stator superconducting windings 228, are arranged in a multiple-pole configuration. For example, in FIG. 11, rotor superconducting windings 216 are shown in a six-pole configuration. In various embodiments, superconductors may be arranged in various configurations (e.g., 2 poles, 4 poles, 10 poles, etc.). In some embodiments, the superconducting windings, such as rotor superconducting windings 216 and stator superconducting windings 228, may be arranged in layers. For example, in FIGS. 11 and 13, the stator superconducting windings 228 are shown in a three-layer arrangement.

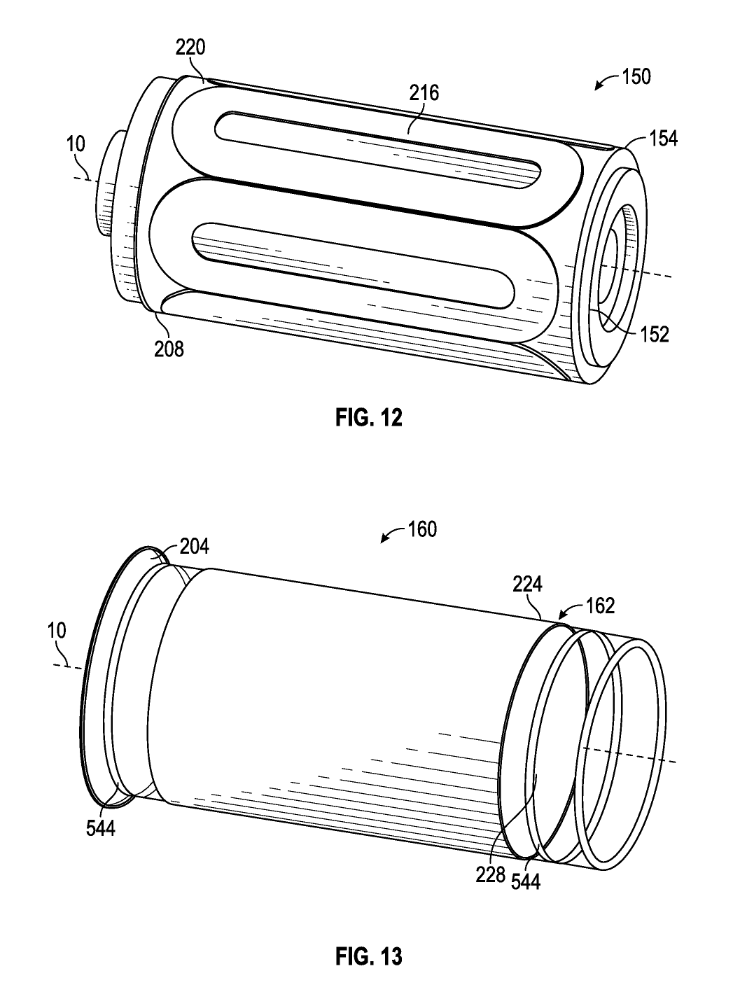

Referring to FIG. 12, a portion of a rotor 150 is shown. The rotor 150 may rotate about a longitudinal axis 10. The rotor 150 may include a rotor torque tube 200. The rotor torque tube 200 may be coannular with and surround an outer surface of a shaft, and may transfer mechanical rotational energy from the shaft to a rotor active section 154 that is coannular with and surrounds an outer surface of the torque tube 200. The rotor active section 154 may include a rotor composite 208 which supports rotor superconducting windings 216 and rotor cooling tubes 220. Rotor cooling tubes 220 may be disposed along an outer surface of the rotor composite 208, allowing for heat transfer from the rotor active section 154 to coolants passing through the rotor cooling tubes 220.

Referring to FIG. 13, a portion of a stator 160 is shown. The stator 160 may be coannular with a longitudinal axis 10. The stator 160 may include an active section 162 including a stator composite 232 which supports stator superconducting windings 228 and stator cooling tubes 224. Stator cooling tubes 224 may be disposed along an inner surface of the stator composite 232, allowing for heat transfer from the active section 162 to coolants passing through the stator cooling tubes 224. In some embodiments, heat sink rings 544 are disposed along an outer circumference of the stator 160, in order to provide a flow of coolants at a temperature that is greater than the temperature of the coolants passing through the cooling tubes 224. In some embodiments, the coolants passing through the heat sink rings 544 include helium at a temperature of 60 Kelvin.

Referring to FIG. 14A, various layers of a stator (e.g., stator 160 shown in FIG. 9) are shown. In some embodiments, the stator 160 includes a stator torque tube 204 supporting a stator active section 162. A stator composite 232 supports stator superconducting windings 228 and stator cooling tubes 224. A stator retention layer 212 may be disposed along an outer surface of the stator composite 232 and may provide additional structural support to the stator 160 during a change in temperature from a first temperature to a second temperature, as well as during operation of the superconducting electrical machine 100 at or below a cryogenic temperature. Stator cooling tubes 224 may be disposed along an outer surface of the stator composite 232, in order to provide a flow of coolants at or below a cryogenic temperature.

Referring to FIG. 14B, various layers of a rotor (e.g., rotor 150 shown in FIG. 9) are shown. In some embodiments, the rotor 150 includes a rotor torque tube 200 supporting a rotor active section 154. A rotor composite 208 supports rotor superconducting windings 216 and rotor cooling tubes 220. A rotor retention layer 212 may be disposed along an outer surface of the rotor composite 208 and may provide additional structural support to the rotor 150 during a change in temperature from a first temperature to a second temperature, as well as during operation of the superconducting electrical machine 100 at or below a cryogenic temperature. Rotor cooling tubes 220 may be disposed between the rotor torque tube 200 and the rotor active section 154 in order to provide a flow of coolants at a temperature at or below a cryogenic temperature.

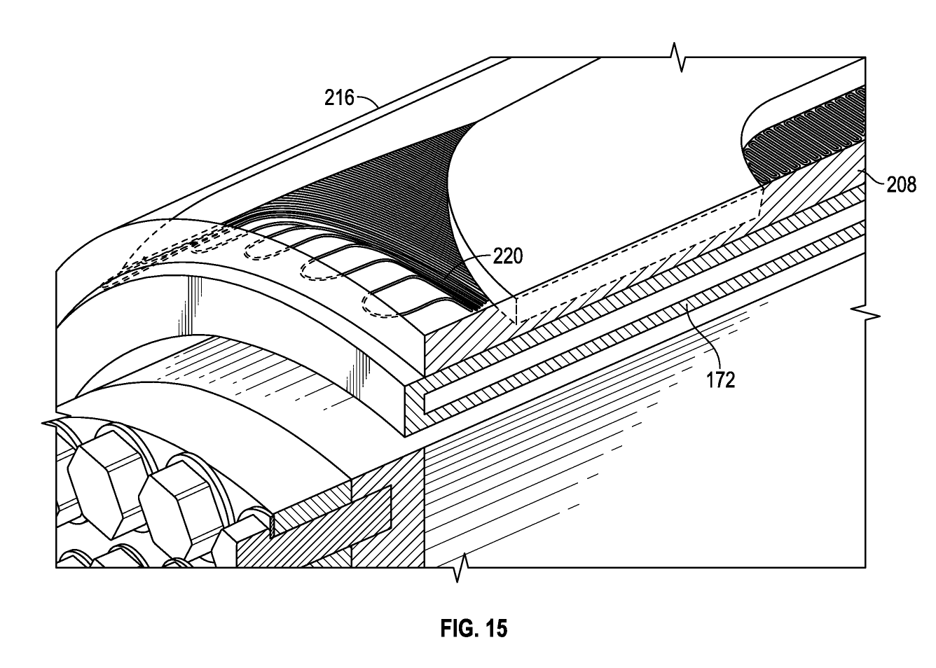

Referring to FIG. 15, a rotor 150 is shown. Rotor re-entrant drive end 172 provides an extended path along which thermal conduction may proceed from the rotor 150 to an environment surrounding superconducting electrical machine 100. Rotor cooling tubes 220 may be provided along an outer surface of a rotor torque tube 200. In some embodiments, rotor cooling tubes 220 are arranged in a tightly wound configuration in order to maximize the surface area between the rotor cooling tubes 220 and rotor windings support composite 208, in order to maximize the rate of heat transfer from the rotor superconductor windings 216 to the coolant passing through the rotor cooling tubes 220.

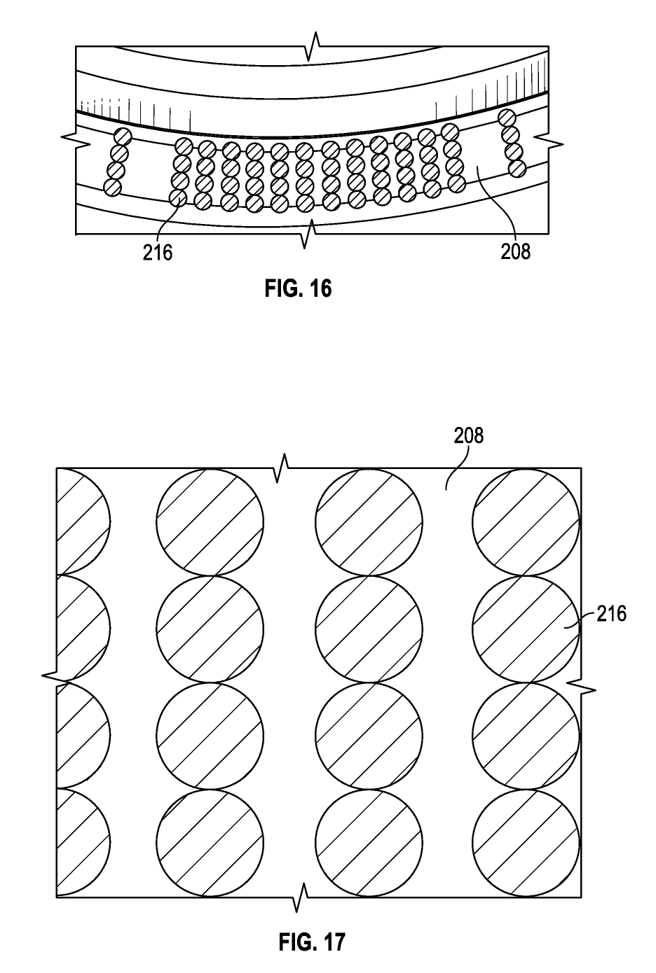

Referring to FIG. 16, a rotor composite 208 is shown. In some embodiments, the rotor composite 208 surrounds and supports rotor superconducting windings 216. In some embodiments, the rotor superconducting windings 216 are arranged in a stacked saddle coil configuration (see, e.g., FIG. 12 for a macro-scale illustration of a stacked saddle coil configuration). Although the figures show the rotor superconducting windings 216 in a stacked saddle coil configuration, in various other embodiments, the rotor superconducting windings 216 may be arranged in various configurations, such as a saddle coil configuration, etc.

Referring to FIG. 17, a detail view of rotor superconducting windings 216 disposed in a rotor composite 208 is shown. The rotor composite 208 may include an epoxy or similar resin and a filler (e.g. spherical beads, etc.). The rotor composite may be configured to compensate for a change in volume which may occur during a change in temperature from a first temperature to a second temperature. In some embodiments, the rotor superconducting windings 216 is disposed within gaps in the rotor composite 208. The gaps may include grooves for supporting the rotor superconducting windings 216. Although FIGS. 16-17 refer to arrangements and configurations of various components of a rotor, in some embodiments, various components of a stator (e.g., stator superconducting windings 228 and a stator composite 232 of stator 160 shown in FIG. 14A) may also follow similar arrangements and configurations.

In some embodiments, a composite such as a rotor composite 208 or a stator composite 228 may include an epoxy resin and a filler. The epoxy resin may be cryogenic toughened, in order to withstand operation at cryogenic temperatures. The epoxy resin may have a very low viscosity, such as a viscosity less than 1000 cps at 25 degrees Celsius. The epoxy resin may have advantageous adhesion to fibers and fillers. In some embodiments, the epoxy resin includes CTD521 resin manufactured by Composite Technology Development, Inc., of Lafayette, Colo. In some embodiments, other resins may be used, including resins similar to epoxy, etc.

The filler may include spherical beads, wherein a volume fraction of the spherical beads in the composite is configured to compensate for a volume change of a rotor 150 or a stator 160, or components of a rotor 150 or a stator 160 (e.g. rotor superconducting windings 216, stator superconducting windings 228, rotor structural material, stator structural material, etc.). The volume fraction may be defined as a volume of the spherical beads divided by a volume of the composite. The volume fraction may be any value greater than zero percent and less than 100 percent. In some embodiments, the volume fraction is greater than or equal to 50 percent and less than or equal to 80 percent. In some embodiments, the volume fraction is 65 percent.

In some embodiments, the spherical beads include solid glass spheres. The solid glass spheres may include E-glass. The spherical beads may have a particle size distribution with a mean value of 30-50 microns. In some embodiments, the use of solid glass spheres advantageously distributes stress in the composite. In some embodiments, the spherical beads are Spheriglass® Solid Glass Microspheres manufactured by Potters Industries LLC of Valley Forge, Pa.

In some embodiments, the spherical beads include a coating layer disposed on an outer surface of the spherical beads. The coating layer may be configured to facilitate bonding with an epoxy resin. In some embodiments, the coating layer includes an inner coating radius and an outer coating radius defining a coating thickness as the difference between the outer coating radius and the inner coating radius. In some embodiments, the coating thickness is configured to facilitate bonding with the epoxy resin. For example, the coating thickness may provide the spherical beads with a sphere size configured to bond effectively with the epoxy resin. The coating may increase bond strength between the resin and the spherical beads.

In some embodiments, a composite is configured to compensate for a volume change occurring during a temperature transition from a first temperature to a second temperature. The first temperature may be any of a variety of temperatures. In some embodiments, the first temperature is related to a temperature at which a superconducting electrical machine 100 is assembled. For example, the first temperature may fall within the range of 273 Kelvin to 373 Kelvin, including a typical room temperature such as 293 Kelvin, 298 Kelvin, etc.

In some embodiments, the second temperature is a cryogenic temperature. A cryogenic temperature may be any temperature at or below which a conductor is able to superconduct. For example, a cryogenic temperature may be any temperature at which superconducting windings, such as rotor superconducting windings 216 or stator superconducting windings 228, are able to superconduct. In some embodiments, the second temperature is a temperature at or below a boiling point temperature of a coolant, such as a boiling point temperature of nitrogen, helium, or other coolants. In some embodiments, a second temperature is a temperature greater than zero Kelvin and less than or equal to 93 Kelvin. In some embodiments, a second temperature is a temperature greater than or equal to 4 Kelvin and less than or equal to 35 Kelvin.

In some embodiments, the second temperature is a temperature at or below a rotor superconducting temperature or a stator superconducting temperature. The rotor superconducting temperature and the stator superconducting temperature may be a temperature at which the rotor superconducting windings 216 and the stator superconducting windings 228, respectively, may superconduct. In some embodiments, superconductor windings, such as rotor superconductor windings 208 or stator superconductor windings 228, include magnesium diboride (MgB₂) as a conductor. The second temperature may be a temperature at or below which MgB₂ may superconduct. In some embodiments, the second temperature is 15 Kelvin.

During operation of a superconducting electrical machine 100, a change in temperature may occur from a first temperature, such as a room temperature, to a second temperature, such as a cryogenic temperature for MgB₂. Various structural changes may occur to the superconducting electrical machine 100 during this temperature transition. For example, various components of the superconducting electrical machine 100 may undergo a change in volume due to thermal contraction. Superconducting windings, such as rotor superconducting windings 216 or stator superconducting windings 228, may undergo a volume change. In order to prevent damage to components due to thermal structural deformations and thermal stresses that develop when different components undergo thermal volume changes of different magnitudes, a composite may be configured to compensate for thermal volume changes.

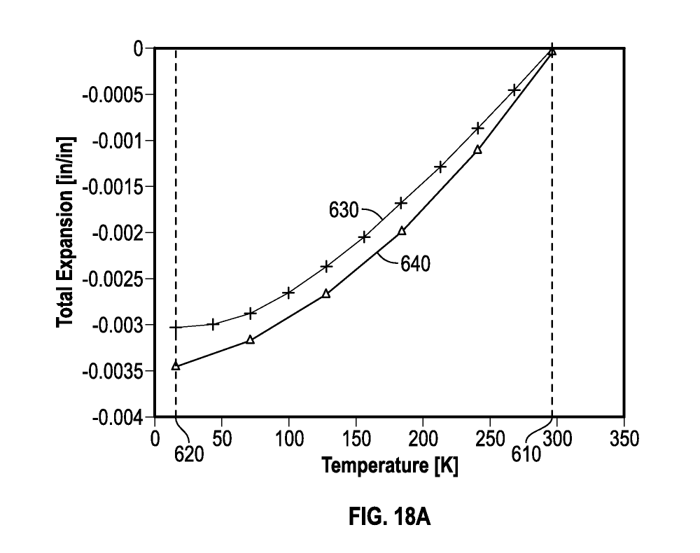

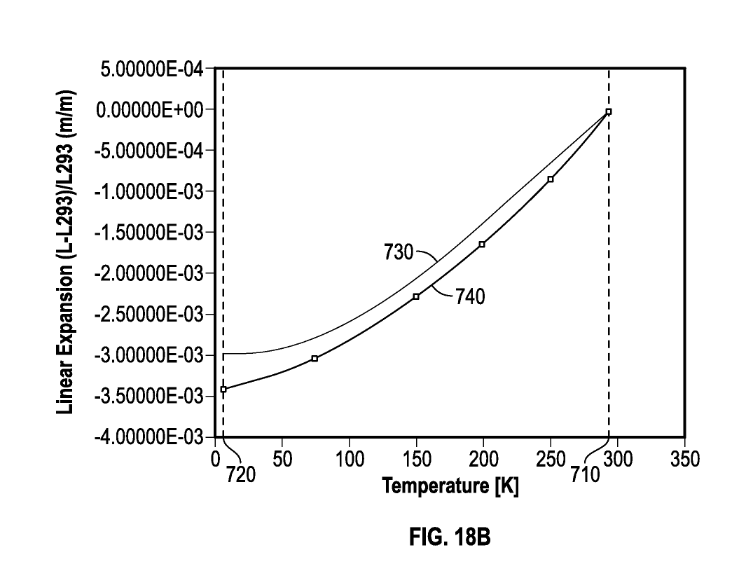

Referring to FIG. 18A, in accordance with one embodiment, a composite including an epoxy resin and a filler including spherical beads is configured to compensate for the thermal expansion coefficient of 304 stainless steel. FIG. 18A illustrates total thermal expansion [inch/inch] of both the composite and 304 stainless steel at various stages of a change in temperature from a first temperature 610 corresponding to a room temperature to a second temperature 620 corresponding to a cryogenic temperature. Curve 630 passes through various data points for measured total expansion of 304 stainless steel. In accordance with one embodiment, curve 630 shows that 304 stainless steel contracts by approximately 0.003 [inch/inch] (i.e. approximately 0.3 percent) during a change in temperature from the first temperature 610 to the second temperature 620. Curve 640 passes through various data points for measured total expansion of the composite. In accordance with one embodiment, curve 640 shows that the composite contracts by approximately 0.0035 [inch/inch] (i.e. 0.35 percent) during a change in temperature from the first temperature 610 to the second temperature 620.

FIG. 18B illustrates contemplated embodiments of linear expansion [meter/meter] of a composite having a volume fraction of 65 percent of glass spheres, and of 304 stainless steel, at various stages of a change in temperature from a first temperature 710 corresponding to a room temperature to a second temperature 720 corresponding to a cryogenic temperature. Curve 730 passes through various data points for linear expansion of 304 stainless steel. In accordance with one embodiment, curve 730 shows that 304 stainless steel contracts by approximately 0.003 [inch/inch] (i.e. 0.3 percent) during a change in temperature from the first temperature 710 to the second temperature 720. Curve 740 passes through various data points for linear expansion of a composite including an epoxy resin of CTD521 and a filler of Spheriglass 3000E, with a volume fraction of the filler of 65 percent. In accordance with one embodiment, curve 740 shows that the composite contracts by approximately 0.0035 [inch/inch] (i.e. 0.35 percent) during a change in temperature from the first temperature 710 to the second temperature 720.

In some embodiments, a volume fraction of a filler in a composite is configured to compensate for a change in volume of a different material (e.g., a rotor 150, a stator 160, rotor superconducting windings 216, stator superconducting windings 228, rotor structural material, stator structural material, etc.) based on the volume fraction, a thermal expansion coefficient of the filler, a thermal expansion coefficient of an epoxy resin also included in the composite, and a thermal expansion coefficient of the different material. For example, an instantaneous coefficient of thermal expansion for the composite (CTE_{C}) may be determined as shown in Equation 1.

CTE_{C}=V_{R}*CTE_{R}+V_{B}*CTE_{B} (1);

where V_{R} is a volume fraction of a resin in the composite, CTE_{R} is an instantaneous coefficient of thermal expansion of the resin, V_{B} is the volume fraction of the spherical beads (i.e. a filler) in the composite, and CTE_{B} is an instantaneous coefficient of thermal expansion of the spherical beads. CTE_{C} may then be compared to the thermal expansion coefficient of the different material (e.g., superconducting windings, etc.), and CTE_{C} may be modified by varying V_{B} in order to configure V_{B} to compensate for a change in volume of the different material during a change in temperature from a first temperature to a second temperature. V_{B} may be configured to compensate for the change in volume if CTE_{C} falls within a target range of the thermal expansion coefficient of the different material (CTE_{D}). For example, the target range may be a determined on a percentage basis, and CTE_{C} may fall within the target range if the magnitude of CTE_{C} is within a percentage of the magnitude of CTE_{D} (e.g., within 25 percent, within 10 percent, within 1 percent, within 0.1 percent, etc.). CTE_{C} may be required to fall within the target range of CTE_{D} during some or all of the change in temperature from the first temperature to the second temperature.

In some embodiments, V_{B} is configured to compensate for a change in volume of a different material if a total expansion and/or a linear expansion of a composite falls within a target range of a total expansion and/or a linear expansion of the different material. For example, as illustrated in FIG. 18A, V_{B} of spherical beads in a composite is configured to compensate for a total expansion of 304 stainless steel. For example, as shown in FIG. 18A, the total expansion of the composite closely tracks the total expansion of the 304 stainless steel: the difference in percent contraction of the composite as compared to the percent contraction of the 304 stainless steel is no greater than 0.05 percent. In some embodiments, the target range is determined based on such a comparison of percent contraction/expansion, and the percent contract/expansion is a value no greater than 10 percent, no greater than 1 percent, no greater than 0.1 percent, etc. The required target range may be influenced by various properties, including but not limited to material properties such as compression strength, shear modulus, Young's modulus, adhesive properties, ductility, viscosity, density, etc. The percent contraction/expansion may be required to fall within the target range during some or all of the change in temperature from the first temperature to the second temperature. In some embodiments, the target range is based on an absolute difference in the magnitude of the total expansion and/or the linear expansion. For example, as shown in FIG. 18B, the difference in the magnitude of the linear expansion of the composite and the magnitude of the linear expansion of the 304 stainless steel is never greater than approximately 0.0005 [m/m]. In some embodiments, the target range is determined based on a difference in absolute magnitude of total expansion and/or linear expansion no greater than 0.01 [m/m], 0.001 [m/m], 0.0001 [m/m], etc.

In some embodiments, V_{B} of a filler in a composite is configured to compensate for a change in volume of a different material such that the composite tends to expand/contract more than the different material. For example, CTE_{C} may consistently, or always, be greater than or equal to CTE_{V}, during a change in temperature from a first temperature to a second temperature. The magnitude of total expansion and/or linear expansion of the composite may consistently, or always, be greater than or equal to the magnitude of total expansion and/or linear expansion of the different material.

In some embodiments, V_{B} of a filler in a composite is configured to compensate for a change in volume of a different material such that the composite tends to expand/contract less than the different material. For example, CTE_{C} may consistently, or always, be less than or equal to CTE_{V}, during a change in temperature from a first temperature to a second temperature. The magnitude of total expansion and/or linear expansion of the composite may consistently, or always, be less than or equal to the magnitude of total expansion and/or linear expansion of the different material.

As shown in the figures and described in the written description, a superconducting electrical machine 100 may be fully superconducting: both a rotor 150 and a stator 160 are capable of operating in a superconducting fashion, as rotor superconducting windings 216 and stator superconducting windings 228 are each able to superconduct when maintained at a temperature no greater than a cryogenic temperature. In other embodiments, a superconducting electrical machine may be partially superconducting. For example, just a rotor, or just a stator, may be configured to superconduct. In some embodiments, only one of a rotor or a stator may be provided with a composite such as rotor composite 208 or stator composite 232. In some embodiments, only one of a rotor 150 or a stator 160 may be provided with cooling tubes, such as rotor cooling tubes 220 or stator cooling tubes 224, in order to maintain respective superconductors at or below a cryogenic temperature.

The construction and arrangement of the systems and methods as shown in the various exemplary embodiments are illustrative only. Although only a few embodiments have been described in detail in this disclosure, many modifications are possible (e.g., variations in size, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A superconducting electrical machine, comprising:
a stator comprising:
stator superconducting windings configured to superconduct when cooled to a temperature no greater than a stator superconducting temperature; and
stator structural material surrounding the stator superconducting windings;
a rotor configured to rotate in a cavity defined by the stator, the rotor comprising:
rotor superconducting windings configured to superconduct when cooled to a temperature no greater than a rotor superconducting temperature; and
rotor structural material surrounding the rotor superconducting windings; and
at least one composite for supporting at least one of the stator superconducting windings, the stator structural material, the rotor superconducting windings, and the rotor structural material, the at least one composite comprising:
a layer including an epoxy resin and a filler, the filler comprising spherical beads defining a volume fraction, wherein the volume fraction is configured to compensate for a volume change of the at least one of the stator superconducting windings, the stator structural material, the rotor superconducting windings, and the rotor structural material during a change in temperature from a first temperature to a second temperature.

2. The superconducting electrical machine of claim 1, wherein the volume fraction is greater than or equal to 50 percent and less than or equal to 80 percent.

3. The superconducting electrical machine of claim 1, further comprising a coating layer disposed on an outer surface of the spherical beads.

4. The superconducting electrical machine of claim 1, wherein the first temperature is a room temperature.

5. The superconducting electrical machine of claim 1, wherein the second temperature is greater than zero Kelvin and less than or equal to 93 Kelvin.

6. The superconducting electrical machine of claim 5, wherein the second temperature is greater than or equal to four Kelvin and less than or equal to 35 Kelvin.

7. A superconducting electrical machine, comprising:
a stator comprising stator superconducting windings configured to superconduct when cooled to a temperature no greater than a stator superconducting temperature;
a rotor configured to rotate in a cavity defined by the stator, the rotor comprising rotor superconducting windings configured to superconduct when cooled to a temperature no greater than a rotor superconducting temperature; and
at least one composite for supporting at least one of the rotor superconducting windings and the stator superconducting windings, the at least one composite comprising:
a layer including an epoxy resin and a filler, the filler comprising spherical beads defining a volume fraction, wherein the volume fraction is configured to compensate for a volume change of the at least one of the rotor superconducting windings and the stator superconducting windings during a change in temperature from a first temperature to a second temperature.

8. The superconducting electrical machine of claim 7, wherein the volume fraction is greater than or equal to 50 percent and less than or equal to 80 percent.

9. The superconducting electrical machine of claim 7, further comprising a coating layer disposed on an outer surface of the spherical beads.

10. The superconducting electrical machine of claim 7, wherein the first temperature is a room temperature.

11. The superconducting electrical machine of claim 7, wherein the second temperature is greater than zero Kelvin and less than or equal to 93 Kelvin.

12. The superconducting electrical machine of claim 11, wherein the second temperature is greater than or equal to four Kelvin and less than or equal to 35 Kelvin.

13. The superconducting electrical machine of claim 7, wherein the at least one of the stator superconducting windings and the rotor superconducting windings comprises magnesium diboride.

14. A superconducting electrical machine, comprising:
a stator comprising:
stator superconducting windings configured to superconduct when cooled to a temperature no greater than a stator superconducting temperature; and
stator structural material surrounding the stator superconducting windings;
a rotor configured to rotate in a cavity defined by the stator, the rotor comprising rotor superconducting windings configured to superconduct when cooled to a temperature no greater than a rotor superconducting temperature; and
rotor structural material surrounding the stator superconducting windings; and
at least one composite for supporting at least one of the rotor and the stator, the at least one composite comprising:
a layer including an epoxy resin and a filler suitable for a cryogenic application, the filler comprising spherical beads defining a volume fraction, wherein the volume fraction is configured to compensate for a volume change of at least one of the stator and the rotor during a change in temperature from a first temperature to a second temperature.

15. The superconducting electrical machine of claim 14, wherein the volume fraction is greater than or equal to 50 percent and less than or equal to 80 percent.

16. The superconducting electrical machine of claim 14, further comprising a coating layer disposed on an outer surface of the spherical beads.

17. The superconducting electrical machine of claim 14, wherein the first temperature is a room temperature.

18. The superconducting electrical machine of claim 14, wherein the second temperature is greater than zero Kelvin and less than or equal to 93 Kelvin.

19. The superconducting electrical machine of claim 18, wherein the second temperature is greater than or equal to four Kelvin and less than or equal to 35 Kelvin.

20. The superconducting electrical machine of claim 14, wherein the at least one of the rotor structural material and the stator structural material comprises at least one of a metal and a metal alloy, and the volume fraction is further configured to compensate for a volume change of the at least one of the rotor structural material and the stator structural material.
